(19) United States
(12) Patent Application Publication
(10) Pub. No.: US 2011/0173569 A1
(43) Pub. Date: Jul. 14, 2011

(54) Preview Functionality for Increased Browsing Speed

(75) Inventors: Timothy Howes, Los Altos, CA (US); Eric Vishria, San Carlos, CA (US)

(73) Assignee: ROCKMELT, INC., Palo Alto, CA (US)

(21) Appl. No.: 12/687,012

(22) Filed: Jan. 13, 2010

(51) Int. Cl. G06F 3/048; G06F 17/30

(52) U.S. Cl. 715/835; 707/707; 707/E17.108

(57) ABSTRACT

An application such as a web browser obtains a set of data items, such as search results received in response to a search query, or a set of articles received from a web feed, the data items collectively comprising links to do external documents, such as web pages. Previewing functionality enables the application to pre-fetch content of the documents associated with the links, and to pre-render images of the documents. Thus, when the user selects a link to preview, a preview is rapidly displayed by reading the pre-rendered image corresponding to the selected link.

### BACKGROUND

The present invention generally relates to the field of software systems, and more specifically, to techniques for enabling a user to more quickly browse through and preview links in a set of data items.

When users examine lists of network-available documents, such as web pages and other items of content available through the Internet and viewable via applications such as web browsers, they are typically uncertain which particular documents contain information of interest to them. Thus, users tend to browse quickly through documents, cursorily examining a document to determine whether it appears relevant and proceeding to another one if not.

Given that users view most documents for only a short time when searching for content of interest, it would be beneficial to enable users to very rapidly obtain a document preview. It would likewise be beneficial to provide users with an interface for rapidly and easily transitioning between the various documents. Unfortunately, conventional systems for viewing network-available documents, such as traditional web browsers, fail to provide the desired functionality. As one example scenario, consider the actions taken as part of a typical Internet search, in which a user submits a search query to a remote search engine and receives a set of search results corresponding to the query. In this scenario, the user's web browser displays the search results within the browser content area. When the user wishes to examine one of the search results and accordingly clicks its associated link, the browser submits a request for the document associated with the link to the relevant content server. The user must then wait while the document—and any content referenced by the item, such as images, videos, external scripts, and the like—are transferred over the network to the user's computer system, and while the browser assembles and renders all the received content. Depending on the speed of the network and the speed of the system on which the browser is executing, this could take a noticeable amount of time, e.g. many seconds. Such delays are not conducive to efficient browsing, in that they discourage users from quickly viewing a large number of documents to find relevant content, as they would typically otherwise do absent the delays.

Further, conventional browsers fail to provide an effective interface for transitioning between documents. Search results are typically displayed within the content area of the browser, and clicking on or otherwise selecting one of the search results causes the browser content area to display the content associated with the selected search result. To view another search result, the user must then select the browser “Back” button to return to the list of search results and then click on a different search result. This process can prove time-consuming and is thus an additional hindrance to rapid browsing between documents.

### SUMMARY

An application such as a web browser obtains a set of data items, such as search results received in response to a search query, or a set of articles received from a web feed, the data items collectively comprising links to external documents, such as web pages. Previewing functionality enables the application to pre-fetch content of the documents associated with the links, and to pre-render images of the documents. Thus, when the user selects a link to preview, a preview is rapidly displayed by reading the pre-rendered image corresponding to the selected link.

In one embodiment, a web browser having a graphical user interface with a content area obtains a set of data items, the set comprising links to web pages. The web browser then retrieves, for each of a plurality of the links, a web page associated with the link and renders the retrieved web pages before any user selection to view them. The browser then receives a user selection to preview a link, and displays the rendered web page associated with the previewed link in the content area.

### BRIEF DESCRIPTION OF DRAWINGS

FIG. 1 is a high-level block diagram of a computing environment 100 according to one embodiment.

FIG. 2 is a screenshot of an example user interface 200 in a window of a web browser application 111 in which the present invention can be employed, according to one embodiment.

FIGS. 3A-3D depict changes in the user interface 200 in response to the execution of an explicit search query and the selection of different search results.

FIG. 4 displays components of the preview module 112 that enable rapid previewing of a document associated with links.

FIG. 5 is a flowchart illustrating the actions performed in order to preview links, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

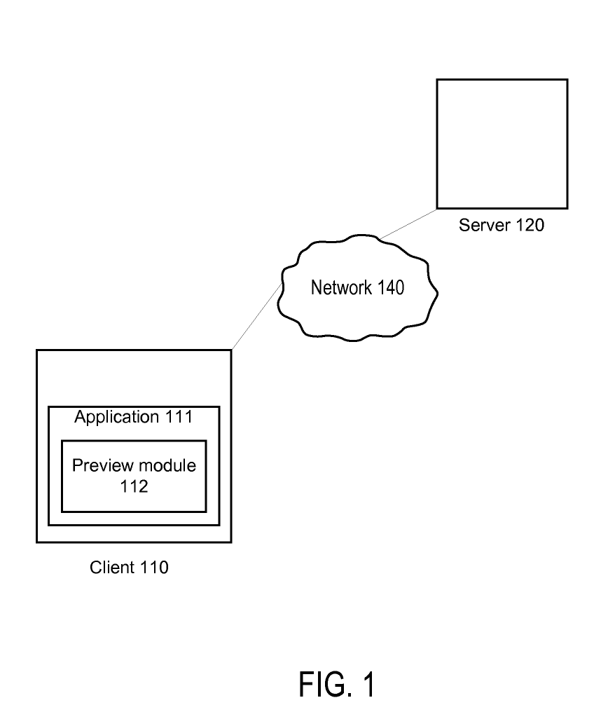

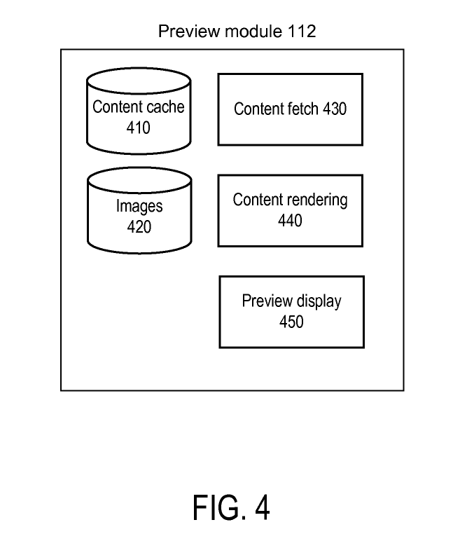

FIG. 1 is a high-level block diagram of a computing environment 100 according to one embodiment. FIG. 1 illustrates a client 110 and a server 120 connected by a network 140. The client executes an application 111, such as a web browser, which obtains data items (e.g., search results, feed articles, or textual messages) from the server 120, the data items comprising links to document such as web pages. The client 110 additionally has a preview module 112—described in more detail below with respect to FIG. 4—which enables rapid previews of documents associated with the links and obtained from the server 120 or other network-available sources. In one embodiment, the preview module 112 is a component of the application 111; in other embodiments, the preview module 112 is not specific to the application 111, but can be embedded within a number of applications, e.g. as a plug-in. FIG. 1 depicts only one client 110 and one server 120 for simplicity, although it is appreciated that there could be any number of each. For example, the client 110 can obtain data items from any number of different servers 120 of different types, such as a search engine providing search results in responses to queries, a feed server providing updates to subscribed-to content, and the like.

The network 140 represents the communication pathways between the client 110 and the server 120. In one embodiment, the network 140 uses standard Internet communications technologies and/or protocols. Thus, the network 140 can transmit data using technologies such as Ethernet, 802.11, integrated services digital network (ISDN), asynchronous transfer mode (ATM), etc. Similarly, the networking protocols used on the network 140 can include the transmission control protocol/Internet protocol (TCP/IP), the hypertext transport protocol (HTTP), the simple mail transfer protocol (SMTP), the file transfer protocol (FTP), the extensible messaging and presence protocol (XMPP), etc. The data exchanged over the network 140 can be represented using technologies and/or formats including the hypertext markup language (HTML), the extensible markup language (XML), JavaScript object notation (JSON), the really simple syndication (RSS) format, etc. In addition, all or some links can be encrypted using conventional encryption technologies such as the secure sockets layer (SSL), transport layer security (TLS), secure HTTP (HTTPS) and/or virtual private networks (VPNs). In another embodiment, the entities can use custom and/or dedicated data communications technologies instead of, or in addition to, the ones described above.

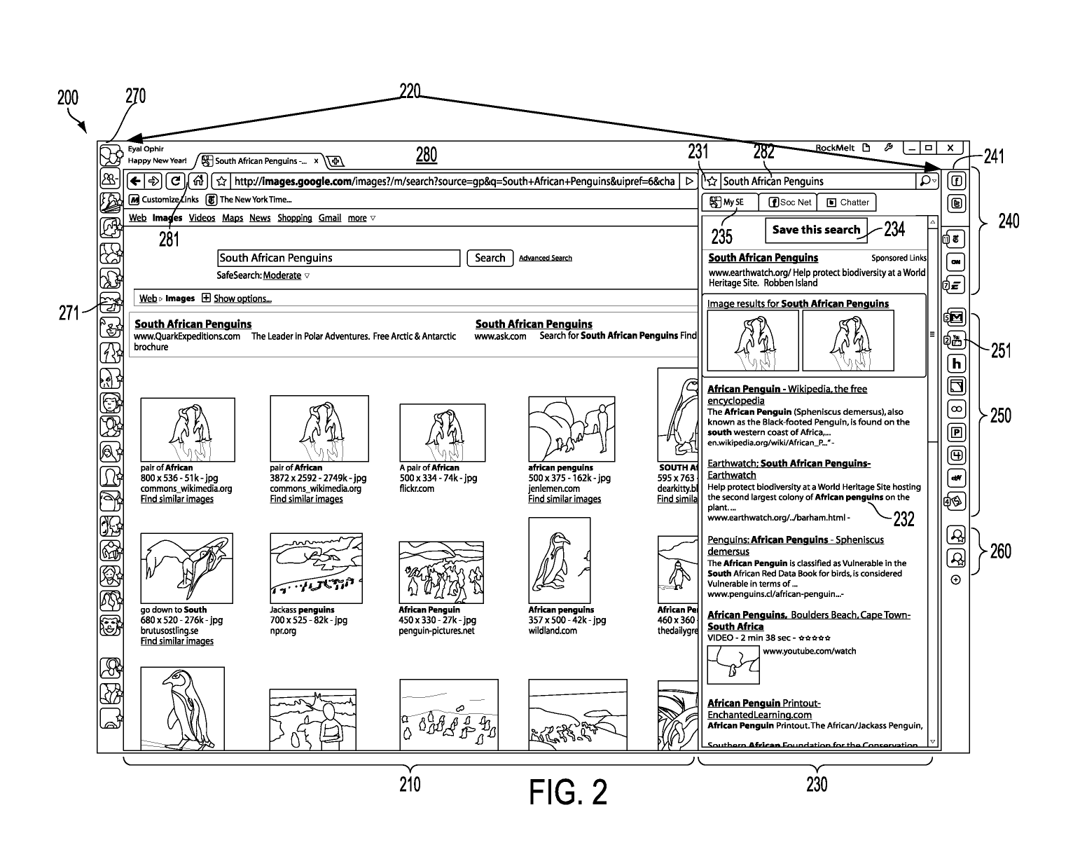

FIG. 2 is a screenshot of an example user interface 200 in a window of a web browser application 111 in which the present invention can be employed, according to one embodiment. The user interface 200 comprises functionality enabling rapid and convenient access to documents, such as web pages, available via a network such as the Internet. More specifically, the user interface 200 comprises a content area 210 configured to display the content of a document. The user interface 200 additionally comprises areas of the browser “chrome” 220, i.e., portions of the browser window, separate from the content area 210, that are not used to render any particular network-accessible documents. For example, areas of the chrome 220 in the interface of FIG. 2 include a toolbar 280, a Friends bar 270, a search area 230, and bars 240, 250, and 260 for feeds, favorite sites, and saved searches, respectively. The various areas of the chrome 220 may remain visible at the same sizes and locations throughout the operation of the user interface 200, or they may be resized, hidden, or displayed in response to user actions. The functionality of the various areas is now described in more detail.

The toolbar 280 comprises browser controls area 281, which includes conventional browser controls such as forward and back buttons for moving forward and backward in the browser history, a reload button for refreshing the currently displayed document, a home button for causing the content area 210 to display a default document, a URL entry area for specifying a document to be displayed, a favorites list containing shortcuts to particular documents, and the like. The toolbar 280 further comprises a query entry area 282, in which a user can specify a query, e.g., by entering textual query terms.

The search area 230 displays a set of search results 232. In one embodiment, the search area 230 additionally comprises a user interface element 234—such as a button or link—causing the current search query (e.g., the text from the query entry area 282) to be added to the saved searches area 260. In one embodiment, the search area 230 is initially not displayed within the user interface 200, but instead appears in response to execution of a query specified in the query entry area 282 and may be hidden again at a later point in time (e.g., explicitly by selecting a toggle visibility icon 231, or implicitly by selecting one of the search results 232 for display within the content area 210). In one embodiment, the size of the search area 230 varies according to the number of search results, e.g., with the search area's height increasing for greater numbers of search results up to some maximum size (e.g., the height of the browser window, or the height of the screen), after which a scroll bar is displayed for viewing the remaining search results not visible in the available area.

Each search result 232 comprises a link to a document (e.g., a web page) obtained from some data source, and may additionally comprise descriptive information, such as an excerpt of text from the data that is relevant to the search query. The data source can be: a search engine (e.g., GOOGLE, YAHOO, BING) executing the search query against an index and providing search results with links to pages; a social networking site (e.g., FACEBOOK, MYSPACE) providing content items such as posts to a user's page on the social network; a blogging service (e.g., TWITTER) providing textual messages, and the like. The data source may be different from the entity that provides the data itself. For example, a search engine data source provides links to documents that are typically hosted by an entity other than the search engine.

In the embodiment of FIG. 2, the search results 232 are obtained from multiple data sources, the browser submitting the search query entered into the query entry area 282 to each data source and aggregating the results obtained therefrom. In one embodiment, the set of data sources queried is fixed; in other embodiments, the set may be specified by a user, e.g., by altering a configuration file or by specifying the sources in a user interface of the browser. In FIG. 2, the aggregated results are grouped using a set of tabs 235, each tab corresponding to one of the data sources, such that selecting one of the tabs (e.g., by clicking on it) displays only the search results obtained from the corresponding data source. In FIG. 2, there are depicted three tabs corresponding to three fictitious data sources: a search engine “My SE,” a social network “Soc Net,” and a blogging service “Chatter;” the “My SE” tab is currently selected, and thus the search results 232 displayed are those obtained from the corresponding search engine. In other embodiments, the search results 232 may be displayed in other groupings, such as interspersed in a single search results list sorted according to relevance scores, each search result displaying an associated indication of the data source (e.g., the text “Soc Net” for the social networking data source), or as a set of groups sequentially displayed, each under a heading containing an associated indication of the data source.

In one embodiment, the search results 232 are ordered in an order different from that of the data source from which they came, based on criteria such as activity on a social networking site. For example, if a user, or the user's friends, on a social networking site have shared a uniform resource locator (URL), or a textual message from a micro-blogging service, with each other on the social networking site, then search results for that URL or textual message can be ranked more highly within the search results than they would otherwise be ranked by a search engine. This leverages the considerable additional information about the user provided by the social networking site to present the search results 232 in an order more relevant to the user.

Another criterion used to rank search results 232 in an order different from that of the data source from which they came is the frequency of occurrence of URLs in a discussion stream, such as that provided by a micro-blogging service such as TWITTER. As one specific example, when a user enters a query the textual messages from the micro-blogging service associated with the query are obtained, the URLs included in those textual messages are extracted (and normalized using URL-expansion functionality of a URL-shortening service, if they are in shortened form), and the most frequent of the resulting URLs are identified. These URLs then are considered of particular importance, and a search result corresponding to one of those URLs is ranked more highly than it would otherwise be ranked.

In one embodiment, a search query entered by the user in the query entry area 282 is associated with a level of popularity based on analysis of messages in a discussion stream. As one particular example, logic in the browser 111 or in a service performing on the browser's behalf submits the query to a micro-blogging service to obtain a set of messages matching the query, identifies a time range including the messages (e.g., from the sending time of the earliest message to that of the latest message), subdivides that time range into some number N of subranges, and determines how many messages correspond to each subrange. Then, based on the trend shown by the number of messages in each subrange, the logic assigns to the query a corresponding indication of a popularity level. For example, a query the terms of which occur increasingly over time up to the present moment could be determined to have a high level of popularity. An indicator of this level of popularity can then be displayed within the user interface 200 to show the user how popular his or her query is with other people.

In one embodiment, a search result 232 may comprise one or more user interface elements, such as clickable links located adjacent to the search result, corresponding to actions that can be taken on content of the search result. The possible actions can be based on the type of the search result, or on the entity providing the data of the search result, for instance. For example, any search result could have a “Share” action causing the associated data to be shared on a particular social networking site, e.g., posting a search result referencing a video to an account of the user on the social networking site. As another example, a search result representing an item posted on a social networking site could have a “Comment” action allowing the user to enter a comment on the item, or a “Like” action allowing the user to specify approval of the item. As a further example, a search result representing a text message, such as a message from a micro-blogging service, could have a “Resend” action that sends a message to all of the user's subscribers, or a “Reply” action that sends the message directly and only to the poster of the original message.

In one embodiment, the actions associated with a search result are accomplished by invoking a method of an API of a web site or application in which the action is to be taken (the API implemented as, e.g., a web service). For example, the “Share” action for data associated with a search result can be performed by invoking an item-posting API function of the social networking site on which the data is to be shared.

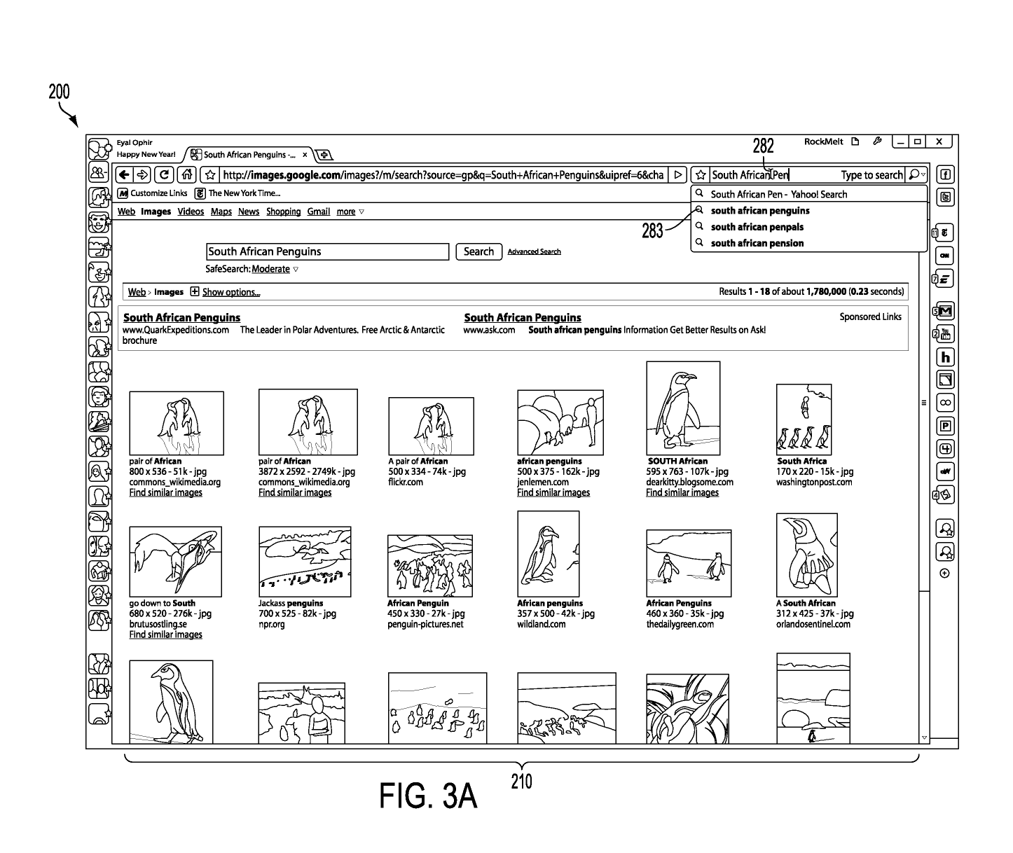

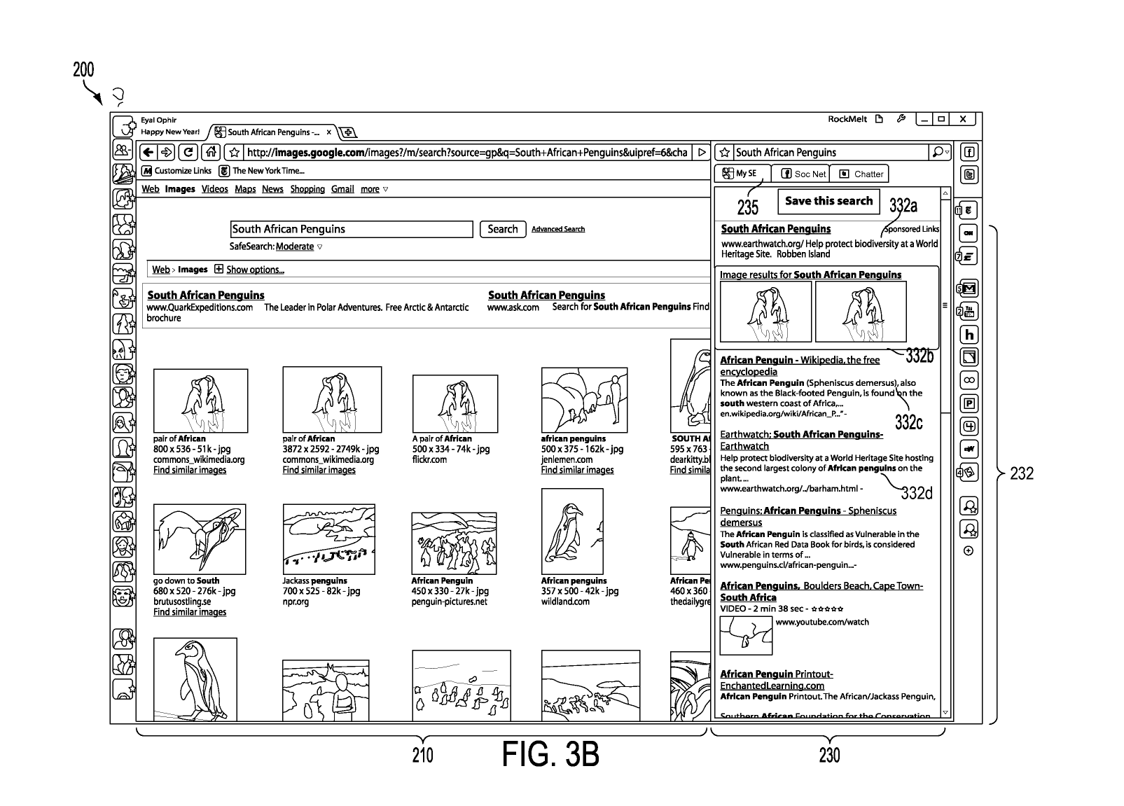

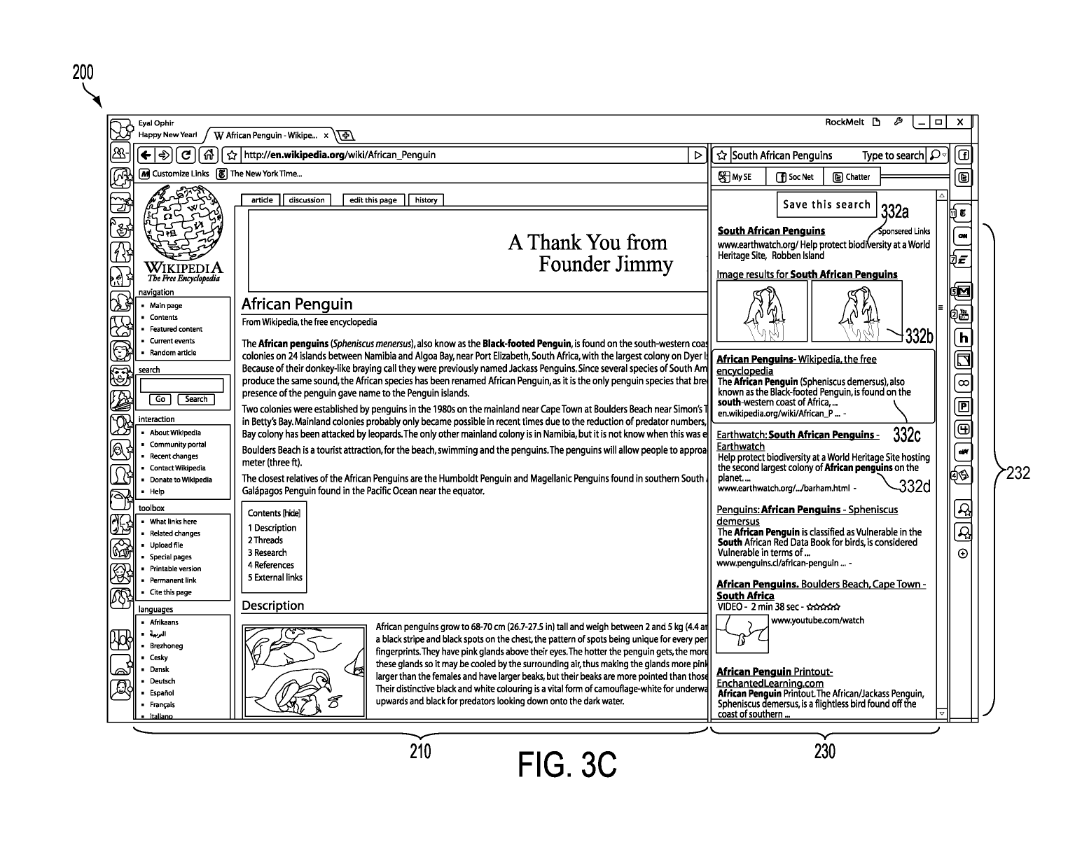

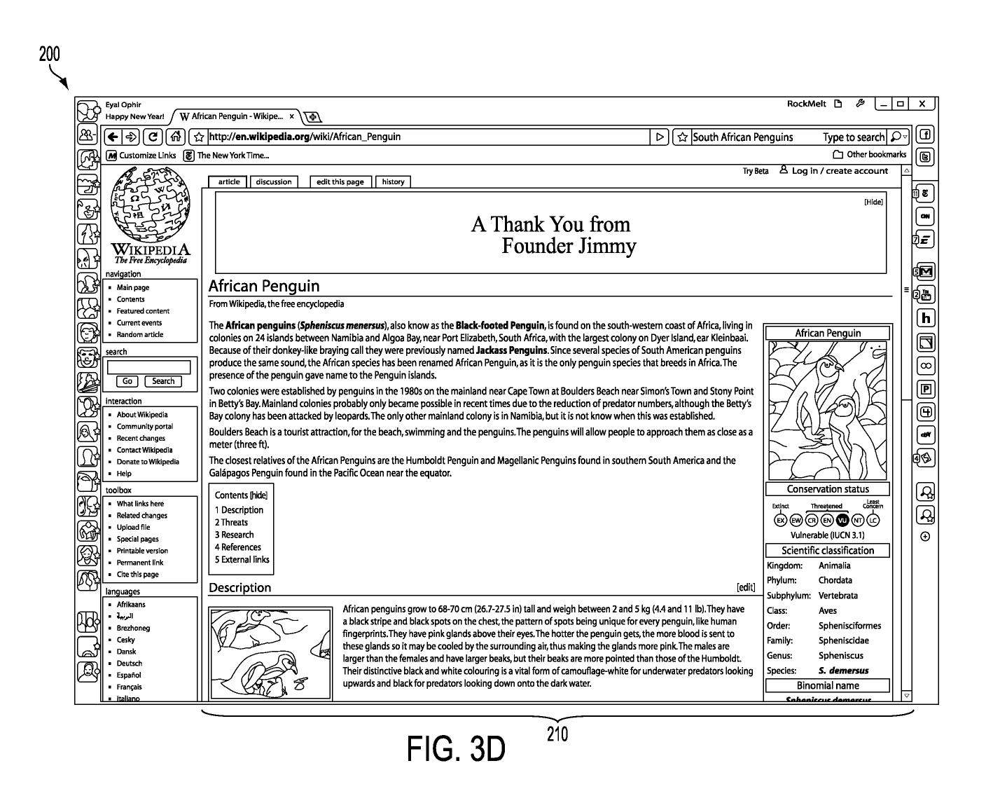

Interactions between the search results 232 and other portions of the user interface 200 are described in more detail with respect to FIGS. 3A-3D, below.

The feeds area 240 displays graphical representations of a set of web feeds to which the browser is subscribed, a feed providing new articles or other data items made available from a particular data source. A feed is represented within the feeds area 240 by an icon 241. Subscription to a feed (and the associated addition of the feed to the feeds area 240) may be accomplished manually by a user, e.g., by clicking on a “Subscribe” button for an RSS feed on a web page, by indicating an interest in given keywords of a micro-blogging service or in a given user's postings on a social networking site, and the like. Alternatively, subscription may be automatic or semi-automatic; for example, logic within the browser could note that the user frequently visits a web page or web site associated with an RSS feed and accordingly add the feed to the feeds area 240, or request the user's permission to do so. In one embodiment, when a new item of content from the feed becomes available a visual indicator is placed on, or otherwise in visual association with, the icon 241 to denote that new feed content is available for viewing. In one embodiment, selecting (e.g., clicking on) an icon displays the items associated with the corresponding feed. The items can be displayed in the content area 210, or in a separate window, for example.

The saved searches area 260 displays a set of searches that the browser periodically executes. As with the feeds of the feeds area 240, a search can be manually added by the user (e.g., by selecting the user interface element 234 of the search area 230) or added automatically or semi-automatically by the logic in the browser (e.g., by noting that the query has been entered in the past, or contains keywords often entered by the user). As with the feeds area 240, each saved search is represented by an icon 251, each of which may be augmented with an associated visual indicator noting that new results have been obtained for the search, and selecting the icon displays the new search results.

The favorite sites area 250 provides visual links to favorite web sites of the user, such that clicking on or otherwise selecting one of the items causes the browser to display the web site in the preview area 210. As with the feeds area 240 and the saved searches area 260, items can be added manually by a user, or can be added automatically or semi-automatically by the browser (e.g., noting that the user has frequently visited the web site).

The Friends bar 270 displays users of a corresponding social networking system with whom the user of the browser is associated on the social networking system. For example, the Friends bar 270 could correspond to the FACEBOOK social networking system, where the users displayed in the bar are first-degree friends of the user on FACEBOOK. In one embodiment, the bar 270 displays users of a plurality of different social networking systems, either separately grouped or intermingled in a single set. In one embodiment, the users displayed within the bar are the highest-ranked friends according to some ranking metric (e.g., number of interactions between the user and the friend) and are sorted in decreasing order of ranking, with the highest-ranked at the top of the list. Each user in the bar 270 has an associated icon 271, such as a current profile picture of the user on the corresponding social networking site. Indicating interest in a user (e.g., by hovering the mouse cursor over the user's icon 271, or by clicking on the icon) displays additional information associated with the user, such as a current status message of the user, links to recent content items posted by the user with optional associated actions such as those described above with respect to search results, and the like. Actions may also be taken with respect to a user, such as (for example) by right-clicking the user's icon 271 and selecting an action from a resulting context menu. Such actions could include initiating (or responding to) a text or video chat with the user, sending an electronic message to the user, and other communication-oriented actions, to name a few. In one embodiment, the data displayed in the Friends bar 270 is obtained and manipulated using an API of the corresponding social networking sites, as described above with respect to search results.

It is appreciated that the user interface 200 is purely for purposes of example, and that other user interface configurations could equally be employed. The various areas of the chrome 220, for example, could be displayed in different locations of the user interface 200, such as along the bottom edge, or as individual floating windows or toolbars separately movable from the main browser window (e.g., after being “torn off” from the main window by the user). The user interface 200 need not comprise all the components described above, and/or it may comprise additional components not described. The various components may also be merged and/or separated in manners different from those described above; for example, the query entry 282 could be located within the search area 230, rather than within the toolbar 280.

FIGS. 3A-3D depict changes in the user interface 200 in response to the execution of an explicit search query and the selection of different search results. In FIG. 3A, a textual search query (i.e., “South African penguins”) is being entered into the query entry area 282 but has not yet been executed. Consequently, the content area 210 does not display any particular search result, but rather displays whatever data was last viewed (illustrated here as blank for the sake of simplicity). In one embodiment, suggested queries are dynamically displayed as the query is being entered, e.g. in a suggestions list box 283. Such suggestions may be based on the current text in the query entry area in combination with one or more of the user's search history, data on the user's friends on a social networking site, and the user's web feed data, for example, or they may be suggestions directly provided by a search engine based on the current query text.

FIG. 3B represents the state of the user interface 200 after the execution of the search query. Search result area 230 has appeared in response to execution of the search query, occupying a portion formerly occupied by the content area 210 in FIG. 3A and displaying a number of search results 232 corresponding to results derived from the data source for the selected tab 235 (i.e., a hypothetical search engine named “MySE”). A first search result 332a comprises a sponsored link, a second search result 332b comprises a set of image thumbnails and links to the original images, a third search result 332c comprises a link to an article, a fourth search result 332d comprises a link to a web page of an organization, and so on.

In one embodiment, the logic of the browser identifies sponsored links (e.g., based on knowledge of placement of sponsored links in the search result set by the data source) and skips over them when assigning the initial focus. Thus, for example, the sponsored link of search result 332a has been skipped over in FIG. 3B, and initial focus has been given to the search result 332b, as indicated by a highlight around the area corresponding to the search result 332b. Accordingly, the content area 210 displays a preview comprising a set of image thumbnails associated with the search result 332b.

FIG. 3C represents the state of the user interface 200 after a different search result has been selected. More specifically, search result 332c, the second non-sponsored search result, has now been selected, causing the content area 210 to display a preview of the article associated with the link of the search result 332c. The transition of focus from the search result 332b to the search result 332c is visually indicated by the highlight moving from the former to the latter. In one embodiment, transition of focus from one search result can be conveniently accomplished with a single key press, such as by using the up or down arrow keys to scroll up or down among the search results 232, causing the content area 210 to display the previous or next search result, respectively. Equivalently, a transition can be accomplished by a mouse click in one of the search results, causing focus to move to that search result. In any case, the separation of the search results area 230 from the content area 210 permits rapid transitions between search results without losing the user's search context provided by the focus within the search results area 230.

In one embodiment, the preview is fully interactive. For example, in the case of a previewed web page, the web page is parsed and rendered as with a conventional web browser (except that the rendering is performed in the background before the page is selected for display, as described below with respect to FIG. 4). Thus, scripts are executed, animation is displayed, links can be selected, and the like. In another embodiment, the preview is a pre-rendered image stored in an image file, as opposed to the interactive representation produced by the parsing HTML code of the website and storing a corresponding document object model in memory, as typically performed by a browser, for example. In one embodiment, if the previewed link was obtained in response to a search query, and if the preview image is too large to fit within the content area 210, then the preview image is “scrolled” to initially display the portion deemed most relevant to the search query. For example, each “div” tag of a web page could be assigned a relevance score with respect to the query, and the preview image could be scrolled so that the portion of the page corresponding to the div tag is visible. The user may then use the scroll bars accompanying the preview image to view other parts of the preview not initially visible.

FIG. 3D represents the state of the user interface 200 after one of the search results has been designated for further viewing after the initial previewing, e.g., by pressing an Enter or Return key of a keyboard to indicate interest in the currently focused search result, or by double-clicking one of the search results. As a result, search result area 230 is hidden, and the content area 210 displays the web page corresponding to the search result. In the embodiment in which the rendered preview is a non-interactive image, the web page can be parsed and displayed in a conventional manner within the content area 210 after the user designates it for further viewing.

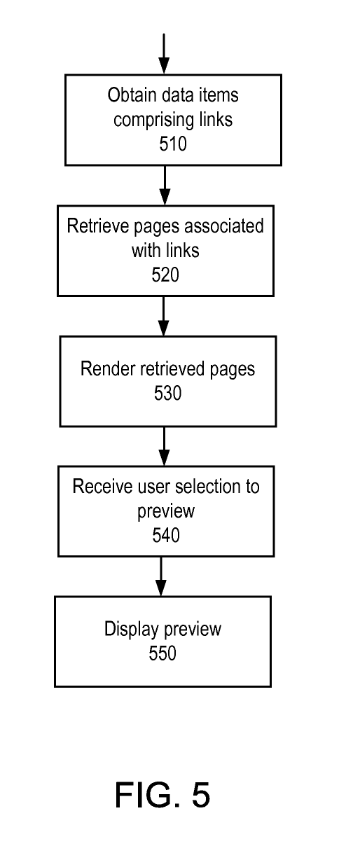

The preview of a document corresponding to a search result can be rapidly displayed in the content area 210 after the selection of one of the search results 232 due to the use of pre-fetching and pre-rendering functionality of the preview module 112, which together generate a preview of content associated with a search result before the user indicates an interest in viewing it. Preview functionality and transitions between search results are described further with respect to FIGS. 4 and 5.

Although the transition between links and the associated previewing of a document associated with the link is described in FIG. 3 within the context of an explicit search query, it is appreciated that transitions and previews are useful within other contexts, as well. For example, updates to a saved search also result in a set of search results, the links of which can be transitioned through and previewed in the same manner discussed above with respect to FIG. 3. As another example, a feed, or a textual message from a micro-blogging service, like a search result set, can comprise a number of links. That is, a news story from a feed, or a textual message, could reference a number of web pages via links, each of which might be of interest to the user. Thus, when viewing a textual message (for example) comprising embedded links, pressing the up and down arrow keys on the keyboard could move between the embedded links, displaying a preview associated with each in the content area 210 of the main browser window. It is therefore appreciated that the below-described pre-fetching and pre-rendering functionality has broad applicability, and is not limited to previewing links associated with search results of an explicit search query.

FIG. 4 displays components of the preview module 112 that enable rapid previewing of documents associated with links (hereinafter for the sake of brevity referred to more simply as “previewing links”). The preview module 112 comprises a content cache 410 and a content fetch module 430. The content fetch module 430 stores content of a document associated with a link to be previewed in the content cache 410. For example, if the link points to a web page referencing external images or other forms of external content, the content fetch module 430 can fetch, and store in the content cache 410 in association with the link, the web page data and the external content referenced by it. In one embodiment, the content fetch module 430 only fetches and stores content needed to generate the preview of the link, and it may also modify or filter the content to save only the portion needed for preview generation. For example, in an embodiment in which the preview generated for a link is a single static graphic, then the content fetch module ignores references to audio content and stores only a single frame of a referenced video. In one embodiment the content cache 410 is an in-memory cache located within main memory of the client 110, e.g., within the memory space of the browser application 111.

In one embodiment, the content fetch module 430 fetches documents (e.g., web pages) in an order in which their corresponding links are likely to be selected by a user, based on the user's past history of interaction with data. This increases the probability that a document will have already been fetched by the time that the user wishes to preview it. For example, the preview module 112 could analyze the browser history, and/or perform its own tracking of user actions to determine which sites the user has viewed most frequently and whether the user typically examines links in a top-to-bottom order, and the like. As a specific example, in the case of search results associated with a search query, where the preview module 112 has determined that the user tends to view links in a top-to-bottom order and often views content from some hypothetical website, mysite.com, the content fetch module 430 might start with links to mysite.com, fetching the corresponding documents in a top-to-bottom order, and then fetch documents corresponding to the remaining links, also in a top-to-bottom order. As another example, the preview module 112 could analyze which feed content the user tends to view, such as content of a particular type (e.g., links, photos), or content posted by a particular author, and use the result of the analysis to determine an order in which to pre-fetch links. In one embodiment, the order of which the documents are fetched is further based on the past histories of interactions of other users with data, in addition to the history of the user himself or herself. For example, clients 110 of other users could transmit their own user history data to the server 120 which could then aggregate and analyze the collected user behavior to determine broad trends in user behavior. The conclusions drawn from this summarized information could then be transmitted to clients 110 for use in deciding the order of fetching. For example, the content fetch module 430 could determine that the aggregate information indicates that a high percentage of users views image files from a particular data source, and so place any such images early in the fetching order.

Although in the above-described embodiment the fetching is performed in a particular order, fetch requests may nonetheless be performed in parallel; that is, the content fetch module 430 may initiate fetching of a first link, and then initiate fetching of a second link while the first link is still in the process of being fetched. In one embodiment, at most some predetermined number of fetches are pending at any given time, the content fetch module 430 waiting to initiate another fetch until one of the current fetches completes.

In one embodiment, the content fetch module 430 only fetches a maximum number of documents, such as a fixed number of documents for a given type of data item (e.g., 10 documents, where the data items are search results, or 3 documents, where the data items are web feed articles). In one embodiment, the content fetch module 430 restricts the rate at which it fetches documents in order not to exceed some maximum data transfer volume, or based on a current amount of data transfer currently being performed by other applications. For example, the content fetch module 430 might delay fetching another document if the fetch and the other fetches currently in progress would require more than 300 kbps of bandwidth, or more than 50% of the data transfer capacity of the connection, or the like. Similarly, it might delay fetching a document if other applications are cumulatively heavily accessing the network (e.g., using 90% of the data transfer capacity of the client 110). In one embodiment, the content fetch module 430 applies a filter to each link to determine whether to fetch its associated document. For example, one filter for search results could exclude documents associated with sponsored links, on the assumption that the user is unlikely to view such documents.

The preview module 112 further comprises a content rendering module 440 for rendering document previews. The content rendering module 440 takes as input the content stored within the content cache 410 and associated with a given link and generates a preview representing the data accessible via the link. For example, in the case of a web page the content rendering module 440 can read the page (in this case, from the content cache 410 rather than from the network 140), parse it, read any referenced content from the content cache, and render the page by laying out its content, placing any referenced content in the relevant portions of the page.

In one embodiment, the content rendering module 440 renders the page within a graphics context that is initially invisible. The content rendering module 440 may thus render multiple pages before they are selected by a user, where they may be quickly displayed simply by making them visible.

In another embodiment the preview module 112 further comprises an images repository 420 to which the content rendering module 440 writes images of the rendered pages. The content cache 410 can be implemented as an in-memory cache within the main memory of the client 110, and/or as secondary storage on the client for longer-term storage of the rendered images. In one embodiment, the generated image includes all the visual content described by the data. For example, if a link refers to a web page, then the image of the link includes all the data of the web page as it would appear at a given moment when rendered within a browser. In one embodiment, the image is static and is stored in a file with a format such as BMP, PNG, JPG, or the like. In other embodiments, the image can additionally include multimedia features, such as animation or sound. The content rendering module 440 then saves the resulting image within the images repository 420 in association with its corresponding link.

It is appreciated that although the content fetch module 430 and the content rendering module 440 are described as separate modules, they can perform their actions cooperatively. For example, the modules 430, 440 can be implemented as a single module that fetches a page, parses the page, identifies the page's references to external content and fetches that content, and then renders the page based on the fetched external content.

The preview module 112 further comprises a preview display module 450 that displays a preview of a document previously pre-rendered by the content rendering module 440. For example, in one embodiment the preview display module 450 selects the invisible graphics context containing the data of the pre-rendered document, places it in the content display area 210, and sets it to be visible. In another embodiment, the preview display module 450 reads the rendered image of a document from the images repository 420 and displays it in the content display area 210.

For example, referring back to FIG. 3C, when the focus has been moved to the search result 332c the preview module 112 determines whether a preview has already been rendered for the link corresponding to the search result. If so, the preview display module 450 previews the link by displaying the preview in the content area 210. Otherwise, it may either cause the content fetch module 430 and content rendering module 440 to produce the preview and then display it, or it may cause the browser 111 to parse and display the document corresponding to the link in conventional browser fashion.

FIG. 5 is a flowchart illustrating the actions performed in order to preview links, according to one embodiment. At step 510, the browser 111 obtains a set of data items (e.g., search results or web feed articles) comprising links to web pages. For example, the browser could obtain a set of search results by submitting a query to a search engine for execution. The search results could have a description and a link to a document, such as the search results provided by a search engine such as GOOGLE, or they could be textual messages as provided by a micro-blogging service such as TWITTER, the textual messages having embedded links referencing external web pages or other documents. Similarly, the browser 111 could obtain one or more new articles from a web feed, the articles having embedded links. The data items are displayed within a user interface region such as the search area 230 of FIG. 2, where the user can then select links to preview.

At step 520, the preview module 112 retrieves, for each of a plurality of the links, a web page (or other document) associated with the link. As discussed above, the preview module 112 need not retrieve all of the web pages referenced by the data items, but can filter out certain of the links, retrieve only a maximum number of the links, and the like.

At step 530, the preview module 112 renders the retrieved web pages before any user selection to view them, e.g. creating interactive versions of the pages in invisible graphics contexts, or creating rendered image files stored in the images repository 420. Although steps 520 and 530 are depicted as distinct sequential actions, step 520 need not be completed before step 530 begins. For example, it is not necessary for all the pages associated with links to be retrieved before any of them are rendered; rather, each successive page (and any referenced external content) may be both retrieved 520 and then rendered 530 (or partially rendered) before the next page is retrieved.

At step 540, the preview module 112 receives a user selection to preview one of the links of the data items obtained at step 510. For example, the user could use arrow keys or tab keys on a keyboard, or mouse actions such as hovering over the link, to move focus from one link to another within the set of data items.

At step 550, the preview module 112 displays the rendered web page associated with the previewed link in the content area 210. This involves determining that a pre-rendered preview for the previewed link has been created, displaying it in the content area if so, such as by setting its graphics context to visible, or by reading it from the images repository 420.

Once steps 510-530 have been performed, the user selection of links to preview and the resulting display of a preview of the link of steps 540 and 550 can be performed virtually instantaneously, with no perceptible delays. This enables a user to rapidly browse through the various links in the data items to identify links having content of interest. The display of the data items within a portion of the user interface—such as the search area 230—separate from the content area 210 in which a link is previewed additionally enables a user to easily transition between the various links and obtain previews via a single key press or mouse click.

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification, such as the client 110 and the server 120, may include a single processor or may be architectures employing multiple processor designs for increased computing capability. The computers include conventional components such as secondary storage devices (e.g., hard disks), primary storage (e.g., main memory such as RAM), network access hardware (e.g. network interface cards), and the like.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A computer-implemented method of previewing a page within a graphical user interface of a web browser, the user interface having a content area, comprising:
obtaining, by the web browser, a set of data items from one or more remote servers, the set comprising links to web pages;
retrieving, by the web browser for each of a plurality of the links, a web page associated with the link;
rendering, by the web browser, the retrieved web pages before any selection by a user of the browser to view the retrieved pages;
receiving, by the web browser, a selection by the user to preview a link; and
displaying, by the web browser, the rendered web page associated with the previewed link in the content area.

2. The computer-implemented method of claim 1, wherein the set of data items comprises search results obtained from a search engine in response to execution of a search query, each of a plurality of the search results having a link to a web page.

3. The computer-implemented method of claim 2, wherein displaying the rendered page comprises scrolling the rendered page such that a portion of content within the page having terms from the search query is initially visible.

4. The computer-implemented method of claim 2, further comprising displaying an indication of a level of popularity of the search query based at least in part on changes in frequency of terms of the search query in textual messages of a discussion stream over time.

5. The computer-implemented method of claim 1, wherein the set of data items comprises an article from a web feed, the article having at least one link to a web page.

6. The computer-implemented method of claim 1, wherein the set of data items comprises a textual message from a blogging service, the textual message having at least one link to a web page.

7. The computer-implemented method of claim 1, further comprising displaying a list of the links in a list area separate from the content area, wherein receiving the selection to preview the link comprises receiving a user input action associated with the link.

8. The computer-implemented method of claim 7, wherein the user input action is a key press causing input focus to move to the link.

9. The computer-implemented method of claim 7, wherein the user input action is one of a mouse-over of the link and a mouse-click on the link.

10. The computer-implemented method of claim 1, wherein the retrieving comprises excluding a page from retrieval responsive to determining that the user would be unlikely to view the page.

11. The computer-implemented method of claim 1, wherein the web pages associated with the plurality of links are retrieved in an order based at least in part on a browsing history of the user.

12. The computer-implemented method of claim 1, wherein the web pages associated with the plurality of links are retrieved in an order based at least in part on browsing histories of a plurality of other users.

13. The computer-implemented method of claim 1, wherein at least one of the data items additionally comprises a user interface element specifying an action, wherein selecting the user interface element causes content associated with the at least one data item to be added to an account of the user on a social networking site.

14. The computer-implemented method of claim 1, wherein a first one of the data items is a search result obtained from a search engine, and a second one of the data items is a content item posted on a social network.

15. The computer-implemented method of claim 1, further comprising delaying the retrieving responsive to a number of web pages that are already in progress of being retrieved.

16. A computer-readable storage medium having executable computer program instructions embodied therein for previewing a page within a graphical user interface of a web browser, the user interface having a content area, actions of the computer program instructions comprising:
obtaining, by the web browser, a set of data items from one or more remote servers, the set comprising links to web pages;
retrieving, by the web browser for each of a plurality of the links, a web page associated with the link;
rendering, by the web browser, the retrieved web pages before any selection by a user of the browser to view the retrieved pages;
receiving, by the web browser, a selection by the user to preview a link; and
displaying, by the web browser, the rendered web page associated with the previewed link in the content area.

17. The computer-readable storage medium of claim 16, the actions of the computer program instructions further comprising displaying a list of the links in a list area separate from the content area, wherein receiving the selection to preview the link comprises receiving a user input action associated with the link.

18. The computer-readable storage medium of claim 16, wherein the web pages associated with the plurality of links are retrieved in an order based at least in part on a browsing history of the user.

19. A computer system for previewing a page within a graphical user interface of a web browser, the user interface having a content area, the computer system comprising:
a computer processor;
a computer program executable by the computer processor and performing actions comprising:
obtaining, by the web browser, a set of data items, the set comprising links to web pages;
retrieving, by the web browser for each of a plurality of the links, a web page associated with the link;
rendering, by the web browser, the retrieved web pages before any selection by the user of the browser to view the retrieved pages;
receiving, by the web browser, a selection by the user to preview a link; and
displaying, by the web browser, the rendered web page associated with the previewed link in the content area.

20. The computer system of claim 20, wherein at least one of the data items additionally comprises a user interface element specifying an action, wherein selecting the user interface element causes content associated with the at least one data item to be added to an account of the user on a social networking site.
